(19) United States
(12) Patent Application Publication
(10) Pub. No.: US 2011/0185899 A1
(43) Pub. Date: Aug. 4, 2011

(54) Methods for Abatement of Arsenic and Phosphorous Contaminants From Fuel Gases Prior to Gasification

(75) Inventors: Larry R. Pederson, West Fargo, ND (US); Olga A. Marina, Richland, WA (US); Christopher A. Coyle, Pasco, WA (US); Gregory W. Coffey, Richland, WA (US); Edwin C. Thomsen, Pasco, WA (US); Liyu Li, Richland, WA (US); Carolyn N. Cramer, Richland, WA (US); Gary L. McVay, Richland, WA (US)

(73) Assignee: Battelle Memorial Institute, Richland, WA (US)

(21) Appl. No.: 12/698,659

(22) Filed: Feb. 2, 2010

(51) Int. Cl. B01D 59/26

(52) U.S. Cl. 95/90

(57) ABSTRACT

Methods for abatement of antimony-containing, arsenic-containing and/or phosphorous-containing impurities in fuel gas that is derived from a carbonaceous source can include contacting the fuel gas with an absorbent comprising a capture compound. The capture compound has one or more alkali metals, one or more alkaline earth metals, or a combination of one or more alkali and alkaline earth metals. The fuel gas impurities are reacted with the capture compound, which can be used alone or dispersed on the adsorbent, at a temperature greater than or equal to approximately 300° C. to form solid capture products comprising antimony, arsenic, or phosphorous and the alkali or alkaline earth metal.

### STATEMENT REGARDING FEDERALLY SPONSORED RESEARCH OR DEVELOPMENT

This invention was made with Government support under Contract DE-AC0576RL01830 awarded by the U.S. Department of Energy. The Government has certain rights in the invention.

### BACKGROUND

Coal, biomass, and other carbonaceous feedstock can be converted into fuel gases for use in the production of electricity, liquid fuels, chemicals, and other products (e.g., through gasification processes). However, the fuel gas commonly contains impurities such as antimony, arsenic and phosphorus, which can poison catalysts used in downstream processes. For example, many of the impurities typically found in coal-derived synthesis gas can result in catalyst poisoning and/or emission of regulated impurities.

To mitigate the negative effects of fuel gas impurities, low-cost, high-capacity methods are needed to, remove those contaminants from a fuel gas stream. While methods to remove impurities including sulfur, chlorine, ammonia, alkali metals, and mercury have been widely addressed, and promising cleanup options have been developed, low-cost methods for the removal of antimony, arsenic, and phosphorus, all of which are typically found in fuel gas derived from coal, and all of which are potent catalyst poisons, are not available. Accordingly, a need exists for low-cost, high-capacity methods of capturing of antimony, arsenic, and phosphorus from fuel gas derived from carbonaceous material.

### SUMMARY

Embodiments of the present invention encompass solid absorbers for the capture of toxic minor and trace impurities, particularly antimony, arsenic and phosphorus, that may be present in fuel gas streams produced from coal, biomass, and other carbonaceous materials. Active elements in the capture compound of the absorber are alkali and alkaline earth metals in various forms or combinations of forms, including oxides, carbonates, hydroxides, and chlorides. The capture compound reacts with the antimony, arsenic, and/or phosphorus that may be present in the fuel gas to form new solid compounds. The formation of these new solid compounds can effectively reduce the gas phase concentration of antimony, arsenic, and/or phosphorus impurities in the fuel gas to inconsequential levels. Transition metals, which can be very expensive, are not included in the preparation of capture compound. Therefore, typically, transition metals are substantially absent from the capture compound. Operation of these absorbers is compatible with conditions for warm gas cleanup.

One embodiment of the present invention includes a method for abatement of antimony-containing, arsenic-containing and/or phosphorous-containing impurities in fuel gas that is derived from a carbonaceous source. The method comprises contacting the fuel gas with an absorbent comprising a capture compound. The capture compound comprises one or more alkali metals, one or more alkaline earth metals, or a combination of one or more alkali and alkaline earth metals. The fuel gas impurities are reacted with the capture compound, which can be used alone or dispersed on the support, at a temperature greater than or equal to approximately 300° C. to form solid capture products comprising antimony, arsenic, or phosphorous and the alkali or alkaline earth metal. In some embodiments, the temperature is less than 800° C. Preferably, the temperature is between 300° C. and 600° C.

The formation of the capture products reduces the partial pressure of impurities in the fuel gas. In some instances, the impurities in the fuel gas are reduced to concentrations less than 20 ppb after treatment by methods of the present invention.

As used herein, a fuel gas refers to a vapor-phase fuel that can be gasified rather than burned. Preferably, the fuel gas is coal gas, biogas, or a combination thereof.

Preferably, the capture compound can comprise oxides, carbonates, hydroxides, and/or chlorides of alkali metals or alkaline earth metals. Most preferably, the alkali or alkaline earth metal comprises potassium and/or sodium. The adsorbent avoids the use of high-cost transition metals such as copper, nickel, iron, manganese, or chromium in the preparation of active absorber material.

The adsorbent can comprise a porous support including, but not limited to, diatomaceous earth. Furthermore, some embodiments of the adsorbent comprise a bentonite clay binder. In preferred embodiments, the capture compound is less than or equal to approximately 5 vol % of the adsorbent.

The purpose of the foregoing abstract is to enable the United States Patent and Trademark Office and the public generally, especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

Various advantages and novel features of the present invention are described herein and will become further readily apparent to those skilled in this art from the following detailed description. In the preceding and following descriptions, the various embodiments, including the preferred embodiments, have been shown and described. Included herein is a description of the best mode contemplated for carrying out the invention. As will be realized, the invention is capable of modification in various respects without departing from the invention. Accordingly, the drawings and description of the preferred embodiments set forth hereafter are to be regarded as illustrative in nature, and not as restrictive.

### DESCRIPTION OF DRAWINGS

Embodiments of the invention are described below with reference to the following accompanying drawings.

FIG. 1 is a graph of area specific cell resistance change for electrolyte-supported cells operated on contaminated coal gas without an absorber of the present invention.

FIG. 2 is a graph of electrolyte-supported cell potential loss as a function of time when exposed to contaminants without an absorber of the present invention.

FIG. 3a is a graph presenting cell area specific resistance change when the contaminated coal gas supplied through the potassium-containing absorber at various gas space velocities (h⁻¹).

FIG. 3b is a graph presenting cell area specific resistance change for barium and calcium absorbers with various gas space velocities (h⁻¹).

### DETAILED DESCRIPTION

The following description includes the preferred best mode of one embodiment of the present invention. It will be clear from this description of the invention that the invention is not limited to these illustrated embodiments, but that the invention also includes a variety of modifications and embodiments thereto. Therefore, the present description should be seen as illustrative and not limiting. While the invention is susceptible of various modifications and alternative constructions, it should be understood, that there is no intention to limit the invention to the specific form disclosed, but, on the contrary, the invention is to cover all modifications, alternative constructions, and equivalents falling within the spirit and scope of the invention as defined in the claims.

According to embodiments of the present invention, capture of antimony, arsenic, and phosphorus from fuel gas by alkali and alkaline earth absorbers occurs through the formation of bulk solid phases. For example, with regard to arsenic, alkali and alkaline earth arsenites have been primarily observed. With regard to phosphorus, alkali and alkaline earth phosphates and pyrophosphates have been primarily observed.

Another embodiment of this invention is the elimination of the support material in the preparation of absorber material. While this approach can be effective, the possibility of agglomeration of reaction products can result in a significant increase in gas flow resistance. The primary purpose of the use of a smaller fraction of active material on a ceramic support is management of an increase in flow resistance with time.

While the capture compound can ostensibly be in the form of oxides, carbonates, hydroxides, and/or chlorides, it is assumed and observed that the capture compound will approach an equilibrium oxide form when exposed to the fuel gas at operating temperatures and pressures.

### Example

### Potassium Carbonate Adsorbent for Fuel Gas Minority Impurities

An absorbent is prepared by dispersing 5 weight percent potassium carbonate onto a diatomaceous earth support mixture with a clay binder. The mixture is formed into pellets approximately 3 mm in diameter. The adsorbent pellets are then heated in air to 600° C. for approximately 2 hours. The heat-treated absorbent pellets are placed into an air-tight alumina tube, heated to 500° C., and synthesis gas that initially contained 10 ppm phosphine is passed through the column at a gas-hourly space velocity of 1000 h⁻¹. A porous nickel film was deposited on a ceramic disk and sealed to the end of the alumina tube. The makeup of principal components of synthesis gas was approximately 25 percent each of carbon monoxide, carbon dioxide, hydrogen, and steam. As determined by XRD, potassium phosphate and potassium pyrophosphate are formed from the reaction in the absorber pellets. No phosphorus-nickel compounds were detected on a downstream metallic nickel film, indicating essentially complete phosphorus removal from synthesis gas.

### Example

### Abatement of Impurities in Coal-Derived Fuels for Anode Reactions

A particular application of the embodiments of the present invention is converting antimony, arsenic, and/or phosphorous contaminants in coal gas into a form that does not interact with Ni-based anodes (e.g., Ni—YSZ). These coal gas contaminants are emphasized because of their tendency to strongly interact with the nickel, leading to extensive grain growth and possible loss of electronic percolation through the anode support.

Five grams of carbonate powder were uniaxially pressed in a one inch metalography die set. The maximum pressure was set to 1500 pounds. The pressed compacts were then broken into rough pieces. The broken compacts were screened so that the test pieces size ranged from ⅛ to ¼ inch maximum dimension. Four grams of these test pieces were inserted into the absorber bed reactor. Twenty sccm of equilibrated, synthetic coal gas with 50 ppm of contaminant gas was introduced into the absorber bed and allowed to percolate through the broken compact test pieces. The reactor bed temperature was controlled at each testing temperatures starting at 600° C. and stepping down in 50° C. increments. The treated coal gas that exited the absorber bed was then introduced to a porous Ni/zirconia coupon. The temperature of the coupon was maintained at 800° C. After 100 hours of exposure the coupon was analyzed for contaminant phases on both the inlet as well as the outlet. Preliminary tests have been performed with these absorbers at a gas hourly space velocity of 1000 h⁻¹ and a phosphine concentration of 50 ppm. No phosphorus breakthrough was observed following 100 hour exposure, and pressure drops remained stable.

In another instance, relative to the previous example, one percent of the carbonate powders, five percent bentonite, and 94 percent diatomite by weight were dry mixed. Water was added to mixed powder to create a slurry of milkshake thickness. This slurry was ball milled overnight to break up any large agglomerates as well as to ensure complete mixing. Drops of the slurry were placed on weighing paper and allowed to air dry overnight, subsequently the drops were placed in an oven and heated to 200° C. for four hours. This process created circular pellets that were 5 mm in diameter and 2 mm in height.

The absorber bed reactor was redesigned in order to test sample pellets at a gas hourly space velocity of 1000 h⁻¹. Simulated coal gas with 50 ppm of contaminant gas was introduced into the absorber bed and allowed to percolate through the test pellets. The reactor bed temperature was controlled at each testing temperatures starting at 600° C. and stepping down in 50° C. increments. The treated coal gas that exited the absorber bed was then introduced to a porous Ni/zirconia coupon. The temperature of the coupon was maintained at 800° C. After 100 hours of exposure, the coupon was analyzed for contaminant phases on both the inlet as well as the outlet using SEM/EDS analysis. No secondary Ni phases were detected.

In order to improve homogeneity of the absorber material, the dry constituents can initially be blended. After the clay binder is distributed throughout the diatomaceous earth, the alkali carbonate and an excess of water can be blended in order to distribute the alkali carbonate evenly throughout all of the available surface area. The resulting slurry can be dried at 100° C. over night. The dried slurry cake can then be further processed through a sieve to improve the handling properties of the materials. The resulting coarse powder is mixed with wax, plastic, and plasticizers in a high shear mixer.

A five gram sample of an absorber mixture processed according to embodiments of the present invention was fired under the same conditions as the “syringe drop” morphology samples described elsewhere herein. Under the “thumb pressure” crush test, the samples appear to be of roughly equivalent strength. When the resultant mixture was ready for the extruder it was the consistency of very smooth dough. The alkali carbonate, clay binder, diatomaceous earth and plastic binder system mixes were extruded into ⅛ inch diameter rods and the chopped into ⅛ inch long pellets.

A gas reaction chamber was constructed in order to expose small amounts of the absorbers of the present invention to a H₂/CO₂ gas stream that contained phosphine or arsine. A small amount of alkali carbonate or alkaline earth carbonate (K₂CO₃, Na₂CO₃, BaCO₃, MgCO₃, CaCO₃, and Mn(CO₃)₂, was placed into a small alumina bucket and exposed to 50 cm³/min of 90% H₂/10% CO₂/50 ppm of either phosphine or arsine for 50 hours. Tests with PH₃ were performed at 500° C., and tests with AsH₃ were performed at 600° C. Obtained samples were further analyzed by micro-XRD to identify the new compounds. In particular, a formation of Na₄As₂O₇ and Na₃AsO₄ from NaCO₃ exposed to arsenic was confirmed. KCO₃ exposed to phosphine was converted to K₂(HPO₄), K₄P₂O₇, and, possibly, K₅P₃O₁₀.

The effective capture temperature range and the breakthrough temperature of each of the carbonates were determined by monitoring the activity of a nickel-zirconia anode for electrochemical hydrogen oxidation. Nickel is an active electrocatalyst for hydrogen oxidation, however it is easily poisoned by low ppm levels of phosphine or arsine at 700-800° C. due to the nickel phosphide and nickel arsenide formation followed by rapid agglomeration of the new phases, which leads to a decrease in the effective electrocatalyst surface area and in the electrical percolation within the anode structure. 30 μm thick Ni/YSZ anodes in the YSZ-electrolyte supported cells show almost immediate degradation after 10 ppm PH₃ and 10 ppm AsH₃ addition to the synthetic coal gas: an area specific resistance of the electrodes increased by a factor of 2-5, at least, during the first 24 hours of exposures to PH₃, while the electrodes irreversibly failed within 15 hours of exposure to AsH₃.

In the following, synthetic coal gas containing 10 ppm PH₃ or 10 ppm AsH₃ was fed to 30 μm thick Ni/YSZ anodes, after passing through an absorber bed of the present invention, while constantly monitoring the rate of the electrochemical reaction (a cell current density). For the absorber, alkali and/or alkaline earth metal carbonates were blended with alumina powder at a ratio of 80 wt % Al₂O₃/20 wt % MCO₃ (M═Na, K, Ba, Ca, Mg, Mn) and 5 grams of the mix was loaded into an alumina tube by holding it in place with alumina wool.

Before the tests, a cell performance baseline was established by operating the cell on the clean coal gas without phosphine or arsine. The absorber temperature was set at 600° C. and 10 ppm PH₃ or AsH₃ was added to the coal gas. Cell performance was recorded constantly over 24 hours, which is sufficient to observe the anode degrade in the presence of only 0.5 ppm PH₃ or AsH₃. Once the anode stability was confirmed, the absorber temperature was lowered by 50° C. Absorber temperature kept dropping by 50° C. every 24 hours until the phosphorus or arsenic breakthrough was established by the cell current decrease (cell resistance increase).

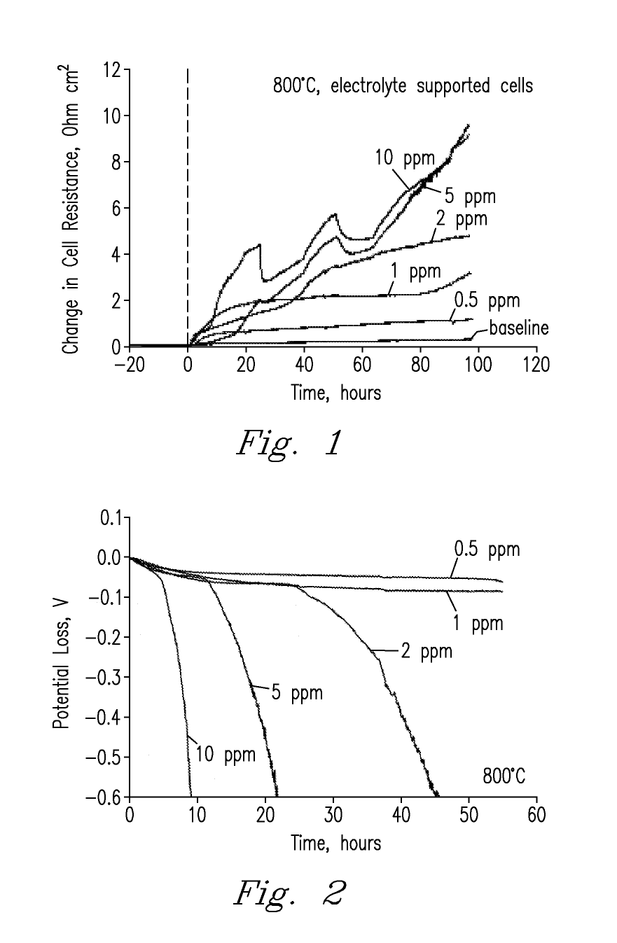

FIG. 1 shows area specific cell resistance data for electrolyte-supported cells operated at 800° C. using coal gas having various concentrations of PH₃ (i.e., baseline, 0.5 ppm, 1 ppm, 2 ppm, 5 ppm, and 10 ppm). No absorber was utilized. The cell resistance increased by a factor of five over 24 hours of exposure to 10 ppm PH₃. FIG. 2 is a plot of cell overpotential loss in time when exposed to various levels of AsH₃ without an absorber of the present invention. The cell completely failed in less than 10 hours of exposure to 10 ppm AsH₃. However, according to embodiments of the present invention, stable cell performance is observed even after introduction of 10 ppm PH₃ when fed through a Ca carbonate or Ba carbonate absorber column at 450° C. or above. Similar performance is observed at temperatures of 500° C. or higher with a Mn carbonate absorber. When the Mn absorber temperature was decreased to 450° C., the cell performance started decreasing indicating that PH₃ was able to reach the Ni anode. Similar tests with a potassium carbonate capture compound resulted in efficient PH₃ capture at temperatures of 450° C. and above. However, the cell started showing performance degradation when the absorber temperature was decreased to 400° C. Table 1 summarizes the PH₃ breakthrough temperatures for various alkali and alkaline earth metal carbonates.

TABLE 1
Summary of the PH₃ breakthrough temperatures for various alkali
and alkaline earth metal carbonates.

| Carbonate | Breakthrough Temperature |
|---|---|
| Mn | 450° C. |
| Ca | 400° C. |
| Ba | 400° C. |
| K | 400° C. |

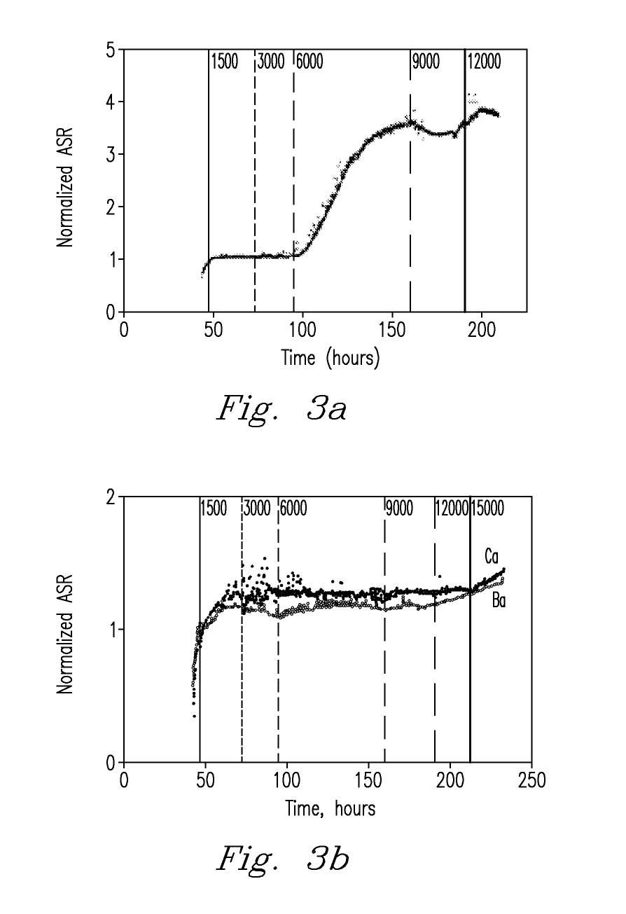

In order to characterize the breakthrough kinetics, various alkali and alkaline earth metal carbonates were wet blended with diatomaceous earth and bentonite at a ratio of 90 wt % diatomaceous earth, 5 wt % bentonite, 5 wt % metal carbonate and dried at 100° C. The resultant powders were combined with a wax based binder system in a high shear mixer for 30 minutes at 130° C. After cooling to room temperature, the resulting mixture was loaded into a single screw extruder, heated to 130° C., and extruded through a ⅛ inch circular die. The extrudites were cooled and cut into approximately ⅛ inch long pieces, then calcined in air at 650° C. for 1 hour. These pellets were loaded into a 0.953 cm ID alumina tube in order to achieve a packed column height of 2.75 cm. Equilibrated coal gas with PH₃ was fed through an absorber at 600° C. and this temperature was held constant. The flow rate of the coal gas was varied to yield different space velocities changing from 1500 to 12000 h⁻¹. The PH₃ concentration was maintained constant and equal to 10 ppm. An increase in the cell area specific resistance would indicate the breakthrough of PH₃ due to the Ni anode poisoning. FIG. 3 illustrates the obtained cell data at different gas space velocities for absorber materials potassium (FIG. 3a), calcium (FIG. 3b) and barium (FIG. 3b) as the basis for the capture compound. The electrolyte-supported cell had 30 μm Ni/YSZ anodes. PH₃ breakthrough occurred at flow space velocities above 3000 h⁻¹ for potassium, above 9000 h⁻¹ for barium, and above 12,000 h⁻¹ for calcium.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A method for abatement of arsenic-containing and phosphorous-containing contaminants in a fuel gas after gasification, the method comprising contacting the fuel gas with an adsorbent having a capture compound comprising alkali metal, alkaline earth metal, or both, reacting the contaminants with the capture compound at a temperature greater than 300° C., forming a capture product comprising arsenic or phosphorous and the alkali or alkaline earth metal, and gasifying the fuel gas having reduced arsenic-containing and phosphorous-containing contaminants.

2. The method of claim 1, wherein the fuel gas is coal gas.

3. The method of claim 1, wherein the fuel gas is biogas.

4. The method of claim 1, wherein the capture compound comprises potassium.

5. The method of claim 1, wherein the capture compound comprises sodium.

6. The method of claim 1, wherein the capture compound is a carbonate.

7. The method of claim 1, wherein the capture compound is an oxide.

8. The method of claim 1, wherein the capture compound is less than or equal to approximately 5 vol % of the adsorbent.

9. The method of claim 1, wherein the adsorbent comprises a diatomaceous earth support.

10. The method of claim 9, wherein the adsorbent further comprises a bentonite clay binder.

11. The method of claim 1, wherein said reacting is at a temperature less than 800° C.
